(19) United States
(12) Patent Application Publication
(10) Pub. No.: US 2004/0218006 A1
(43) Pub. Date: Nov. 4, 2004

(54) Scanning apparatus

(76) Inventor: Stephen Lang Dickerson, Atlanta, GA (US)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/834,713

(22) Filed: Apr. 29, 2004

Related U.S. Application Data
(60) Provisional application No. 60/466,581, filed on Apr. 30, 2003.

(51) Int. Cl. B41J 23/00

(52) U.S. Cl. 347/37

(57) ABSTRACT

Disclosed herein are apparatus and method that provides reciprocating motions of a traveling head utilizing a propulsion member at each end of the reciprocating motion and highly accurate short motions perpendicular to the reciprocating motions. These short motions compensate for the imperfections of the apparatus and/or the surface being scanned or modified. The propulsion member is arranged to recover much of the mechanical energy of the traveling head and apply that energy to the return motion. The reciprocating head travels on a guide of low drag. The short motions that provide an accuracy of scanning or modifying not realizable by mechanical precision rely on stored displacements and a high bandwidth linear servo system.

### CROSS-REFERENCE TO RELATED APPLICATION

This application claims priority to copending U.S. provisional application entitled, “A HIGH-SPEED SCANNER DRIVEN BY HIGH FORCE RETURN MECHANISM AND MADE ACCURATE BY LEARNED SURFACE PROFILES,” having U.S. Ser. No. 60/466,581, filed Apr. 30, 2003, which is entirely incorporated herein by reference.

### TECHNICAL FIELD

The present invention is generally related to a scanning apparatus, and, more particularly, is related to an apparatus and method for scanning properties of a surface or modifying the properties of a surface where it is necessary to move a sensor or tool accurately with respect to the surface. Further, the apparatus is scanning or modifying in a high-speed, reciprocating motion that allows the scanning or modifying to be done rapidly.

### BACKGROUND

An example of a scanning apparatus includes a raster imaging a circuit board or other similar surface with a range sensor. Another example is the raster imaging a machined surface with a sensor that can detect material properties and prints a pattern on a surface at high speed, such features as 3D or material characteristics. To do these tasks, extreme precision, or more specifically repeatability, is required in the two directions vertically and horizontally perpendicular to the reciprocating motion so that an undistorted image or surface can be produced.

A drawback of the raster is the difficulty of providing the high speed and accurate motion of a traveling head without having a very large, expensive, and high power servo drive. A second drawback is that the accurate short motions in the directions that are perpendicular vertically and horizontally to the direction of reciprocating motion are dependent on the precision of the mechanism including the deleterious effects of mechanical deflections and vibrations. Such deflections and vibrations are exacerbated by higher reciprocating speeds and by the motion of any required tethers to the traveling head. A third drawback is the dependence on precision of the surface being scanned or modified. If such a surface, for example a circuit board or piece of paper is not constrained to a precision of flatness then the operations of the scanner are compromised. Thus measures must be taken to make the surface flat which may be expensive or impractical.

Thus, a heretofore unaddressed need exists in the industry to address the aforementioned drawbacks.

### SUMMARY

The disclosed scanning apparatus is to scan properties of a surface or modify the properties of a surface where it is necessary to move a sensor or tool accurately with respect to the surface. As examples, the elevation profile and material composition of a circuit board, the roughness of a machined surface, or the optical profile of a printed surface. The sensor(s) used are housed in a traveling head that is traversing the surface in an oscillatory manner. The word “sensor” is to be understood to be both a sensor or tool throughout this disclosure.

The sensor(s) may be themselves moved small distances relative to the traveling head in an active manner to achieve better performance. The scanning apparatus has at least one, or a combination, of the following features: (1) a low friction linear bearing, (2) a method of a force return at the ends of travel, (3) a method of sensing a velocity and a position of the traveling head at least once during each traverse, (4) a means of returning sensor data to a stationary location, (5) a means of providing electric power to the sensor(s), (6) a computing device to provide for nearly constant and programmed velocity during each traverse, (7) control action to maintain the sensors in a preferred location relative to the surface, and (8) methods of isolating the force return mechanism.

Embodiments of the present invention provide an apparatus and method for scanning and/or modifying a surface at a velocity, preferably at nearly constant velocity during each traverse. A scanning apparatus comprises a traveling head, at least one propulsion member, and a computing device. The traveling head travels in a linear motion and the propulsion member propels the traveling head at a velocity at the ends of travel. The scanning apparatus further comprises an air supply that facilitates propelling the traveling head. The propulsion member can be a pneumatic cylinder assembly, which is capable of receiving air from the air supply and propelling the traveling head. The computing device determines the velocity of the traveling head from a velocity data and controls the pneumatic cylinder assembly to modulate the velocity of the traveling head that is nearly constant and predetermined velocity during each traverse.

In an alternative embodiment, a scanning apparatus comprises a traveling head, at least one propulsion member, and a computing device. The traveling head travels in a linear motion and the propulsion member propels the traveling head at a velocity at the ends of travel. The computing device determines the velocity of the traveling head from a velocity data and controls the propulsion member to modulate the velocity of the traveling head. The scanning apparatus further comprises a table and a track that is mounted on the table. The track allows the traveling head to travel in the linear motion. The scanning apparatus further comprises a suspended structure that is mounted on the table. The suspended structure is mounted with the propulsion members that are arranged at the ends of travel of the traveling head. The suspended structure in conjunction with the propulsion member dampens bouncing forces so that the scanning apparatus as a whole settles into a periodic motion with both the traveling head and the suspended structure moving back and forth. If the bouncing forces were transmitted to the same structure that holds the linear bearings and the surface being scanned or modified, such forces would cause accelerations and deflections of such same structure and make more difficult to have an accurate knowledge of relative position and velocity of the sensor(s) and the surface at all times.

In an alternative embodiment, a scanning apparatus comprises a traveling head, at least one propulsion member, and a computing device. The traveling head travels in a linear motion and the propulsion member propels the traveling head at a velocity at the ends of travel. The computing device determines a velocity of the traveling head from a velocity data and controls the propulsion member to modulate the velocity of the traveling head. The scanning apparatus further comprises a table and a track that is mounted on the table. The track allows the traveling head to travel in the linear motion. The scanning apparatus further comprises a beam structure that is mounted separate from the table. The beam structure is mounted with the pneumatic cylinders at the ends of travel of the traveling head.

In an alternative embodiment, a scanning apparatus comprises a traveling head, at least one propulsion member, and a computing device. The traveling head travels in a linear motion and the propulsion member propels the traveling head at a velocity at the ends of travel. The computing device determines a velocity of the traveling head from a velocity data and controls the propulsion member to modulate the velocity of the traveling head. The traveling head is mounted with a sensor that is arranged at a distance from the surface of the material. The distance of the sensor is adjustable so as to compensate for the inaccuracies of the construction of the air bearing or the flatness of the surface of the material. The adjustable distance between the traveling head and the surface of the material is based on a learned profile, which is data obtained from previous and nearby scans of the surface.

In an alternative embodiment, a propulsion manager is stored in a computer-readable medium contained in a computing device. The manager receives a velocity data and determines the time of impact between a traveling head and a pneumatic cylinder assembly based on the velocity data. The manager also determines the velocity of the traveling head and controls the supply of air to the pneumatic cylinder assembly to put the pneumatic cylinder assembly at a precharged volume and pressure before the impact of the traveling head and pneumatic cylinder assembly based on the velocity data.

Other systems, methods, features, and advantages of the present invention will be or become apparent to one with skill in the art upon examination of the following drawings and detailed description. It is intended that all such additional systems, methods, features, and advantages be included within this description, be within the scope of the present invention, and be protected by the accompanying claims.

### BRIEF DESCRIPTION OF THE DRAWINGS

Many aspects of the invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 is a schematic view of an embodiment of a scanning apparatus.

FIG. 2 is a block diagram of an embodiment of the scanning apparatus shown in FIG. 1.

FIG. 3 is a block diagram of an embodiment of the scanning apparatus shown in FIG. 1.

FIG. 4 illustrates an embodiment of operation of a sequence of events for one traverse of the traveling head shown in FIG. 2.

FIG. 5 is a block diagram of an embodiment of the pneumatic cylinder assembly shown in FIGS. 2 and 4.

FIG. 6 shows an embodiment of a valve used to supply air to the precharge section of the pneumatic cylinder assembly shown in FIG. 5.

FIG. 7 illustrates an embodiment of a mounting arrangement of the propulsion member and the traveling head shown in FIG. 1.

FIG. 8 illustrates an embodiment of a mounting arrangement of the propulsion member and the traveling head shown in FIG. 1.

FIG. 9 illustrates an example of the surface of a material relative to the curvature path of a traveling head.

FIG. 10 illustrates a high-level example of operation of the computing device shown in FIGS. 1, 2, and 3.

FIG. 11 illustrates an embodiment of operation of a propulsion manager stored in the computing device shown in FIGS. 1, 2, and 3.

### DETAILED DESCRIPTION OF THE DRAWINGS

Disclosed herein are apparatuses and methods through which a surface of a material can be scanned or modified. In particular, the surface can be scanned or modified using a propulsion member that propels a traveling head at a predetermined velocity based on velocity data gathered as the traveling head travels across the surface. Example apparatuses are first described with reference to the figures. Although these apparatuses are described in detail, they are provided for purposes of illustration only and various modifications are feasible. After the example apparatuses have been described, examples of operation of a computing device are provided to explain the manner the computing device controls the velocity of the traveling head.

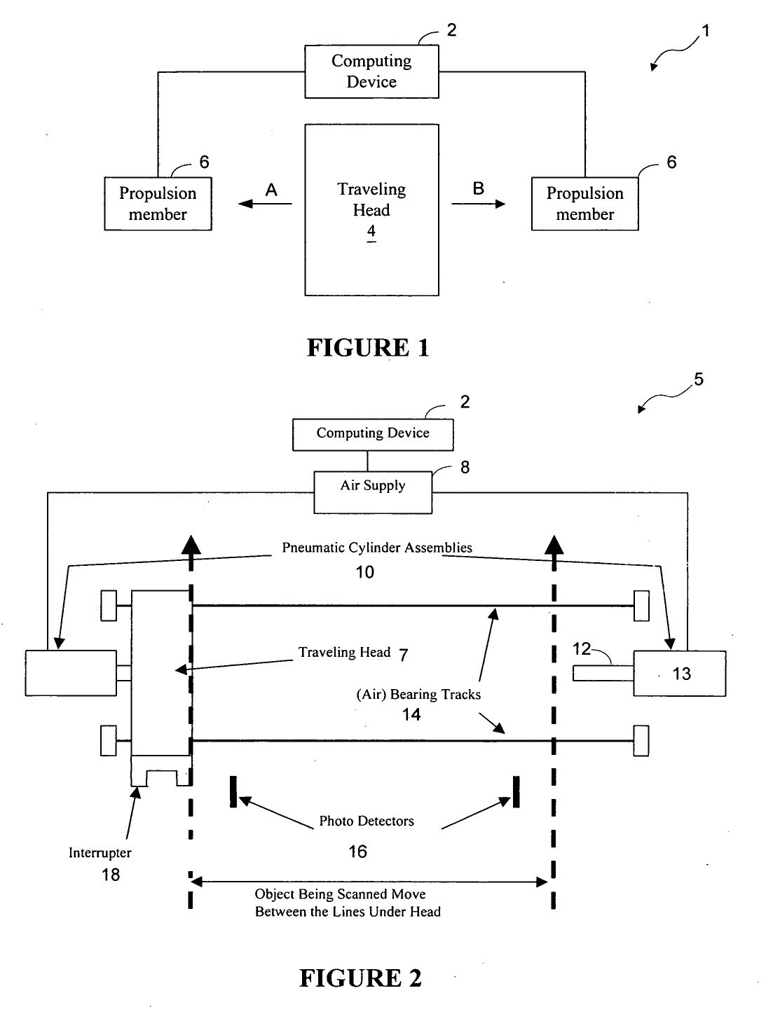

Referring now in more detail to the figures in which like reference numerals identify corresponding parts, FIG. 1 is a schematic view of a scanning apparatus. The scanning apparatus 1 typically includes a computing device 2, at least one propulsion member 6, and a traveling head 4. The traveling head 4 travels in a linear motion in directions A and B located between two propulsion members 6. The propulsion member 6 is arranged at the end of travel of the traveling head 4. The propulsion member 6 propels the traveling head 4 at a velocity, which can be determined by the computing device 2. The computing device 2 can also determine the time of impact between the traveling head 4 and the propulsion member 6. The computing device 2 is coupled to the propulsion member 6 and controls the propulsion member 6 to modulate the velocity of the traveling head 4 for nearly constant and predetermined velocity during each traverse.

FIG. 2 is a block diagram of an embodiment of the scanning apparatus shown in FIG. 1. The scanning apparatus 5 comprises a traveling head 7, which is mounted with an air bearing (not shown) that is coupled to a set of parallel air bearing tracks 14. The air bearing and air bearing tracks allow the traveling head 7 to travel with low friction at a velocity and support the traveling head 7 as the traveling head 7 traverses over a surface. The air bearing and air bearing tracks also allow the traveling head 7 to travel in a linear motion. The air bearing can be a combination of a cylindrical bearing and a flat bearing arranged so as to constrain the motion of the traveling head 7 to a linear motion without over constraint.

A computing device 2 is coupled to an air supply 8 and the air supply 8 is coupled to pneumatic cylinder assemblies 10. The computing device 2 controls the air output of the air supply 8 to the pneumatic cylinder assemblies 10. The pneumatic cylinder assemblies 10 receive air from the air supply 8 and the air is used to propel the traveling head 7. The computing device 2 can monitor the amount of air contained in the air supply 8 and notify a user that the air supply 8 is low and needs to be replace or refilled.

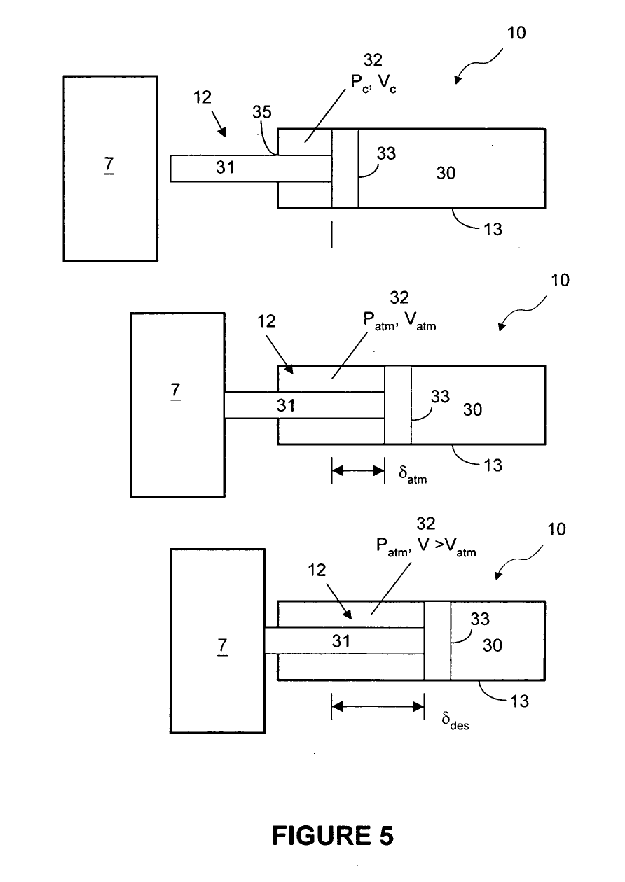

The pneumatic cylinder assemblies 10 are arranged at the end of travel of the traveling head 7 and propels the traveling head 7 at a velocity needed to cause a rapid back and forth motion of the traveling head 7. Each pneumatic cylinder assembly 10 comprises a piston 12 and a cylinder 13. The pneumatic cylinder assembly 10 is pre-pressurized with a precharged volume of air to facilitate propelling the traveling head in the opposite direction, which is described in detail in FIG. 5. A sensor or other instrument (not shown) can be mounted on to the traveling head 7 and directed to a surface.

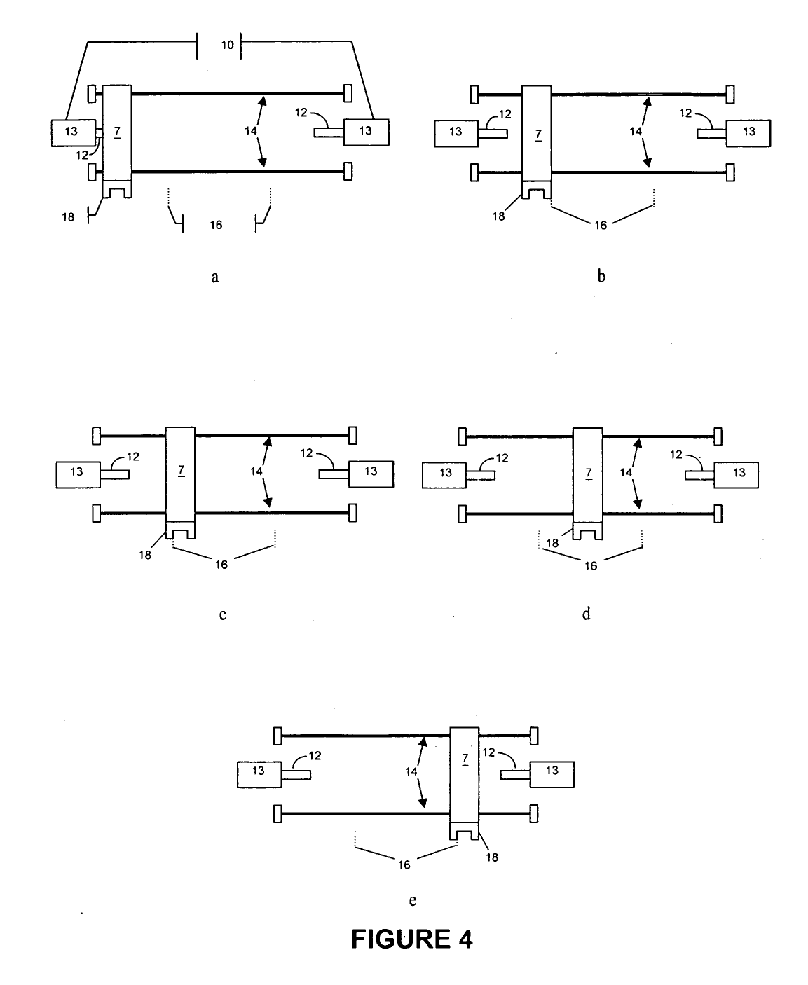

The scanning apparatus 5 further comprises photo detectors 16 that facilitate detecting the velocity of the traveling head 7. The photo detectors 16 provides a velocity data as an interrupter 18 mounted on the traveling head 7 passes through the photo detectors 16 as the traveling head 7 travels in a linear motion along the air bearing tracks 14 between the pneumatic cylinder assemblies 10. The computing device 2 uses the velocity data to calculate the velocity of the traveling head 7 and modulate the amount of air supplied to the pneumatic cylinder assemblies 10. The air provides the propulsion force that propels the traveling head 7 at the desired velocity. The computing device 2 can determine the time of impact between the traveling head 7 and the pneumatic cylinder assemblies 10 so that the propulsion force of the pneumatic cylinder assemblies 10 can be modulated before the impact. The sequence of event for one traverse of the traveling head 7 is further described in FIG. 4.

The scanning apparatus 5 can further comprise an air tank (not shown) that is mounted on the traveling head 7 for the air bearing of the traveling head 7. The air tank supplies air to the air bearing to allow the traveling head 7 to travel with low friction at a velocity. The air in the air tank can be replaced or refilled tetherlessly. For example, a needle-like tube (not shown) can be arranged at each end of travel of the traveling head 7 and engages the traveling head 7 at each end of travel during the impact between the traveling head 7 and the pneumatic cylinder assemblies 10. The needle-like tube supplies air from the air supply 8 through an inlet (not shown) of the air tank.

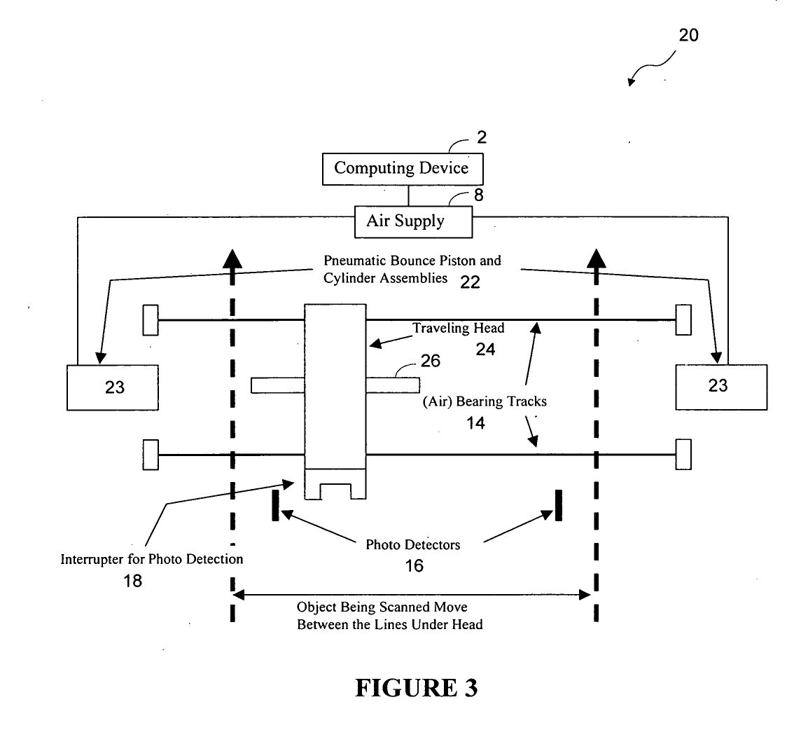

FIG. 3 is a block diagram of an embodiment of the scanning apparatus shown in FIG. 1. The scanning apparatus 20 is similar to the scanning apparatus 5 shown in FIG. 2 and therefore includes a computing device 2, air supply 8, photo detectors 16, interrupt 18, air bearing, air bearing tracks, air tank, and needle-like tube. However, referring to FIG. 3, the traveling head 24 is mounted with pistons 26 on each side of the traveling head 24 and the pneumatic cylinder assemblies 22 have no pistons protruding out of the cylinders 23. The pistons 26 engage and enter the pneumatic cylinder assemblies 22 at the ends of travel when the traveling head 24 impacts the pneumatic cylinder assemblies 22. The pneumatic cylinder assemblies 22 propel the traveling head 24 using the air supplied from the air supply 8. The pistons 26 can further be fabricated as cylindrical rods that are coupled to the air tank. When the traveling head 24 impacts the pneumatic cylinder assemblies 22, the cylindrical rod can receive air from the pneumatic cylinder assemblies 22 , which is supplied to the air tank.

It should be noted that the pneumatic cylinder assembly 22 is not pre-pressurized with a precharged volume of air before the impact of the traveling head 24 the pneumatic cylinder assembly 22 to facilitate propelling the traveling head in the opposite direction. Instead, at the apex of the entrance of the piston 26, air is added to propel the traveling head 24 in the opposite direction.

FIG. 4 illustrates an embodiment of operation of a sequence of events for one traverse of the traveling head 7 shown in FIG. 2. In position a) the traveling head 7 is being launched from the left pneumatic cylinder assembly 10 under the influence of a precharged pressure. In position b) and c) the left photo detector 16 provides a velocity data to the computing device 2 that indicates the traveling head 7 is passing the left photo detector 16 at a point in time at a predetermined position. During the travel to the right in position d) calculations are being made so as the right pneumatic cylinder assembly 10 can be provided with a precharged pressure that causes the traveling head 7 to be propelled at a desired velocity on the return from the right pneumatic cylinder assembly 10.

At position e) the right photo detector 16 provides a velocity data to the computing device 2 that indicates the traveling head is passing the right photo detector at a point in time at a predetermined position. The velocity data from both the left and right photo detectors 10 allows the computing device 2 to calculate a precharged pressure for the right pneumatic cylinder 10. The computing device 2 can further calculate the time of impact between the traveling head 7 and the pneumatic cylinder assembly 10 and the velocity of the traveling head 7 based on the velocity data. There are many variations on this measurement and control operation including the more common situation of replacing the interrupter 18 and photo detector 16 with a typical linear encoder scheme and making all calculations based on that information. This information is also required to correlate the actions and/or measurements at the traveling head 7 with the underlying the surface.

It should be noted that sequence of events shown in FIG. 4 can be applied to pneumatic cylinder assembly 22 shown in FIG. 3. The sequence of events includes position a), b) and c). However, at position d), the computing device 2 is calculating an amount of air to be supplied to the right pneumatic cylinder assembly 10 at the apex of the entrance of the piston 26 so as to propel the traveling head 7 at a desired velocity on the return from the right pneumatic cylinder assembly 10. At position e) the right photo detector 16 provides a velocity data to the computing device 2 that indicates the traveling head is passing the right photo detector at a point in time at a predetermined position. The velocity data from both the left and right photo detectors 10 allows the computing device 2 to calculate the amount of air to be supplied the right pneumatic cylinder 10.

FIG. 5 is a block diagram of an embodiment of the pneumatic cylinder assembly 10 shown in FIGS. 2 and 4. The pneumatic cylinder assembly 10 includes a piston 12, a precharge section 32, and a pressurized section 30. The pressurized section 30 is pressurized by an air supply usually at a constant pressure greater than atmosphere. The piston 12 comprises a piston rod 31 and a piston head 33. The piston rod 31 is attached to the piston head 33 and the piston rod 31 that protrudes out of the pneumatic cylinder assembly 10 through opening 35. The piston rod 31 is in the precharge section 32 of the pneumatic cylinder assembly 10. FIG. 5a shows the position of the traveling head 7 immediately prior to the impact with the piston rod 31. Before the traveling head 7 impact the piston rod 31, the precharge section 32 of the pneumatic cylinder assembly 10 has been supplied with a precharged volume, V_{c}, of air to a certain pressure, P_{c}, based on the velocity data of the photo detectors 16 mentioned with reference to FIG. 4.

FIG. 5b shows the traveling head 7 impacting the piston rod 31 which causes the precharged volume to expand and the pressure to decrease. FIG. 5b further shows that the piston 12 has been deflected by ₐₜₘ and the volume has been expanded to a critical level, Vₐₜₘ, where the pressure is equal to atmospheric, Pₐₜₘ. The expansion of the air adds energy (provides propulsion force) to the pneumatic cylinder assembly 10 to propel the traveling head 7 back in the opposite direction. The pneumatic cylinder assembly 10 functions similarly to a pneumatic spring instead of having to supply all the energy to propel the travel head 7 in the opposite direction. The precharge section 32 is opened to the atmosphere to allow the pressure to remain at atmospheric while the traveling head 7 continues to deflect the piston 12.

FIG. 5c shows the traveling head 7 at zero velocity at the apex of deflection and the deflection of the piston 12 at _{des}. At this point, the pressure differential across the piston 12 will force the head back in the opposite direction. The precharge section 32 will remain open to the atmosphere so that as the volume in the precharge section 32 decreases, air can be expelled and the pressure will still remain at atmospheric.

While the traveling head 7 is traveling down and back along the track, the precharge section 32 will be supplied with a precharged volume, V_{c}, of air to a certain pressure, P_{c}, based on the velocity data of the photo detectors 16 to await the next impact.

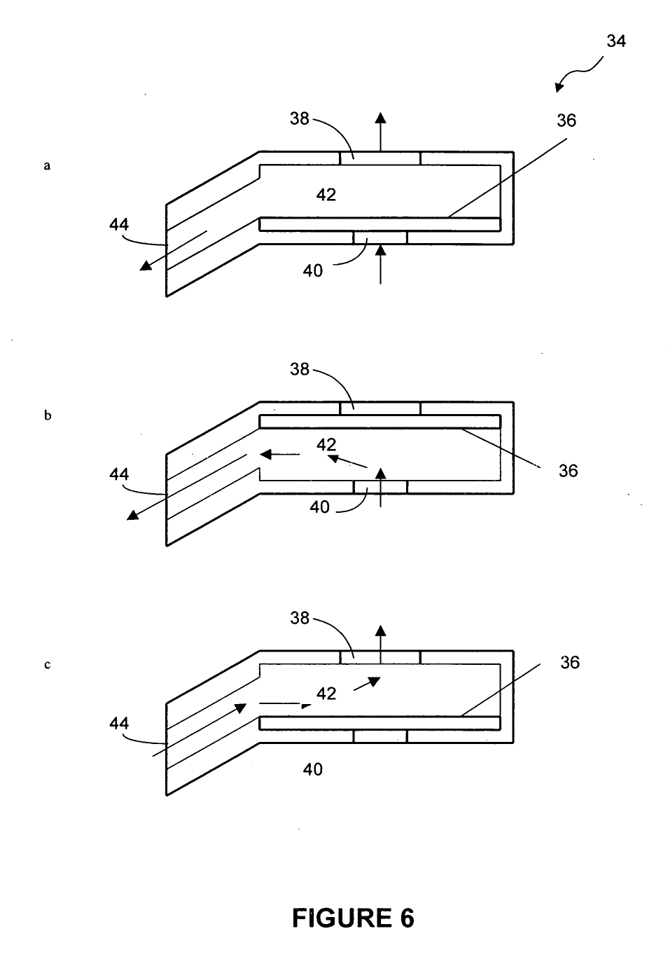

FIG. 6 shows an embodiment of a valve used to supply a precharged volume to the pneumatic cylinder assembly 10 shown in FIGS. 2, 4, and 5. The valve 34 allows the air in a precharge section 32 to expel to the atmosphere when the piston 12 begins to propel the traveling head 7 back in the opposite direction. The computing device 2 controls a solenoid valve (not shown) to dispense air into the precharge section 32 at a precharged volume. The solenoid valve is capable of transferring air into the precharge section 32 through the valve 34 in the available time for a desired velocity before the traveling head 7 impacts the pneumatic cylinder assembly 10.

The valve 34 comprises a disk 36, a cavity 42, a cavity outlet 38 to atmosphere, a cavity inlet 40 from the solenoid valve, and a cavity outlet 44 to the precharge section 32. Inside the cavity 42 is the disk 36. The outlet of the solenoid valve is connected to the cavity inlet 40 and the cavity outlet 44 is connected to the inlet of the precharge section 32 of the pneumatic cylinder assembly 10. FIG. 6a shows the disk 36 resting at the bottom of the cavity 42 blocking the cavity inlet 40 due to gravity or spring force before the precharge section 32 is pressurized with a precharged volume. When the disk 36 is at this position, the precharged volume in the precharge section 32 is open to the atmosphere and so the precharge section 32 is at atmospheric pressure.

FIG. 6b shows the disk 36 at the top of the cavity 42 below the cavity outlet 38 when the precharge section 32 is being pressurized to the precharged volume. When the solenoid valve opens and begins to supply air to the precharge section 32, the force of the flowing air pushes the disk 36 to the top of the cavity blocking the outlet 38 to the atmosphere and allowing the pressure in the volume to increase. The solenoid valve closes after an amount of air has been supplied to the precharge section 32 so that the precharge section 32 reaches the precharged pressure, P_{c}. The disk 36 remains at the top of the cavity since the pressure in the precharge section 32 is greater than the pressure in the atmosphere. The valve 34 remains in this state in preparation for the traveling head 7 impact on the pneumatic cylinder assembly 10.

FIG. 6c shows the disk 36 blocking cavity inlet 40 when the pressure in the precharge section 32 reaches atmospheric pressure during the impact between the traveling head 7 and the pneumatic cylinder assembly 10. As described with reference to FIG. 5, when the traveling head 7 impacts the pneumatic cylinder assembly 10, the volume increases and the pressure decreases in the precharge section 32. When the pressure in the precharge section 32 reaches atmospheric, the disk 36 falls to the bottom of the cavity 42 due to gravity or spring force because the pressure in the precharge section 32 is no longer greater than the pressure in the atmosphere. This connects the precharged volume directly to the atmosphere, which maintains the precharged volume at a constant pressure while the traveling head 7 continues to deflect the piston 12. After the traveling head 7 has reached the apex of deflection the piston 12 begins to move back in the opposite direction because the pressure differential across the piston 12 will force the traveling head 7 back in the opposite direction. During after the apex of deflection, air is forced out of the volume of the precharge section 32 through the cavity outlet 38 so that the precharge section 32 remains at atmospheric pressure.

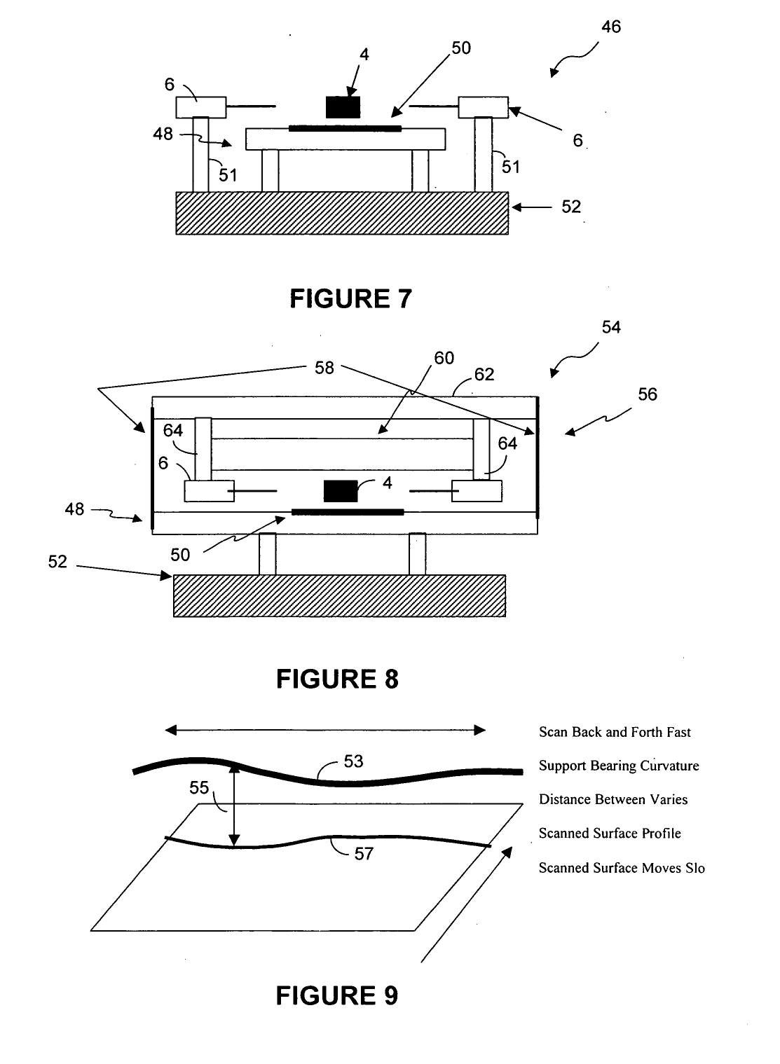

FIG. 7 illustrates an embodiment of the scanning apparatus 1 shown in FIG. 1 where the propulsion member 6 is independently attached to a beam structure 51 that is mounted to a floor 52 separate from the traveling head 4. The mounting arrangement of the scanning apparatus 46 minimizes the effect of the large bouncing forces on the relative position of the traveling head 4 and the surface 50 of a material. The bouncing forces are caused by the traveling head 4 impacting the propulsion member 6 and the propulsion member 6 propelling the traveling head 4 in an opposite direction. The propulsion member 6 is independently mounted to the floor 52, preferably a very heavy rigid floor typically made of concrete. The traveling head 4 is mounted on a table 48 via an air bearing track. The table 48 is mounted to the floor 52.

FIG. 8 illustrates an embodiment of the scanning apparatus 1 shown in FIG. 1 where the propulsion member 6 is mounted on the table 48 of the traveling head 4. The mounting arrangement of scanning apparatus 54 also minimizes the effect of bouncing forces on the relative position of the traveling head 4 and the surface 50 of a material. The scanning apparatus 54 includes propulsion member 6 mounted above the table 48 via a suspension structure 56. The suspension structure 56 is mounted on the table 48 and includes a support member 58 that is mounted to the table 48. The support member 58 is attached to a top support member 62. The top support member 62 is attached to a heavy structure 60 via suspended members 64. The heavy structure 60 in conjunction with the propulsion member 6 is preferably at a weight that dampens bouncing forces so that the scanning apparatus 54 as a whole settles into a periodic motion with both the traveling head 4 and the heavy structure 60 moving back and forth.

It should be noted that the traveling head shown in FIGS. 1, 2, 3, 4, 5, 7, and 8 can further include a sensor (not shown) coupled to the traveling head, preferably between the traveling head and the material surface. The sensor is electrically powered by a power source tetherlessly. The power source can be at least in part by a battery or capacitor that stores electric energy or at least in part provided by a solar cell attached to the traveling head and a light is arranged to shine on the solar cells. The light could be visible or invisible wavelength. Where the power source is a battery or capacitor, the battery or capacitor can be recharged by contacts when the traveling head impacts the pneumatic cylinders. Alternatively, the power source can be at least in part provided by transformer action with a coil moving with the head and one or more coils or magnets stationary and there being no contact between the coils. The traveling head can communicate with the computing device via wirelessly. The wireless communication is by modulated light, including the infrared or radio.

FIG. 9 illustrates an example of the scanned or modified surface of a material relative to the curvature path of a sensor. FIG. 9 illustrates the fact that neither the curvature path 53 of the sensor nor the surface profile 57 is precisely flat and so there is a systematic variation of height 55 between the two items. This systematic variation 55 can be detected by a range sensor (not shown) of conventional design and with processing of that data the variation can be constructed. In some applications the surface has intentional projections and/or depressions that are not a part of the desired variation in height for this purpose. An example would be a circuit board where components are on the surface. Data processing techniques are known for reconstructing the underlying surface.

The scanning apparatus of FIGS. 1, 2, 3, 7, and 8 uses the data that represents constructed variation of height 55 between the curvature path 53 of the sensor and the surface profile 57. A servo (not shown) within the traveling head can adjust the sensor to hold the sensor at a constant distance away from the curved surface. The servo can hold the sensor at the constant distance away from the curved surface based on a learned profile, which is data obtained from previous and nearby scans of the surface. Further, the curvature path 53 (or profile of the surface 57) being measured will usually vary with the slowly moving surface. The learned profile can be accurately updated using the data of both the previous curvatures and data newly acquired by the range sensor. The range sensor can in fact be located so as to precede the active measurement device in the traveling head, making such estimates even better. A similar approach is taken if straightness of the path of the sensor is required in addition to or instead of the height above the underlying surface. Thus, the distance between the sensor and the surface can be adjustable so as to compensate for the inaccuracies of the construction of the air bearing or the flatness of the surface of the material.

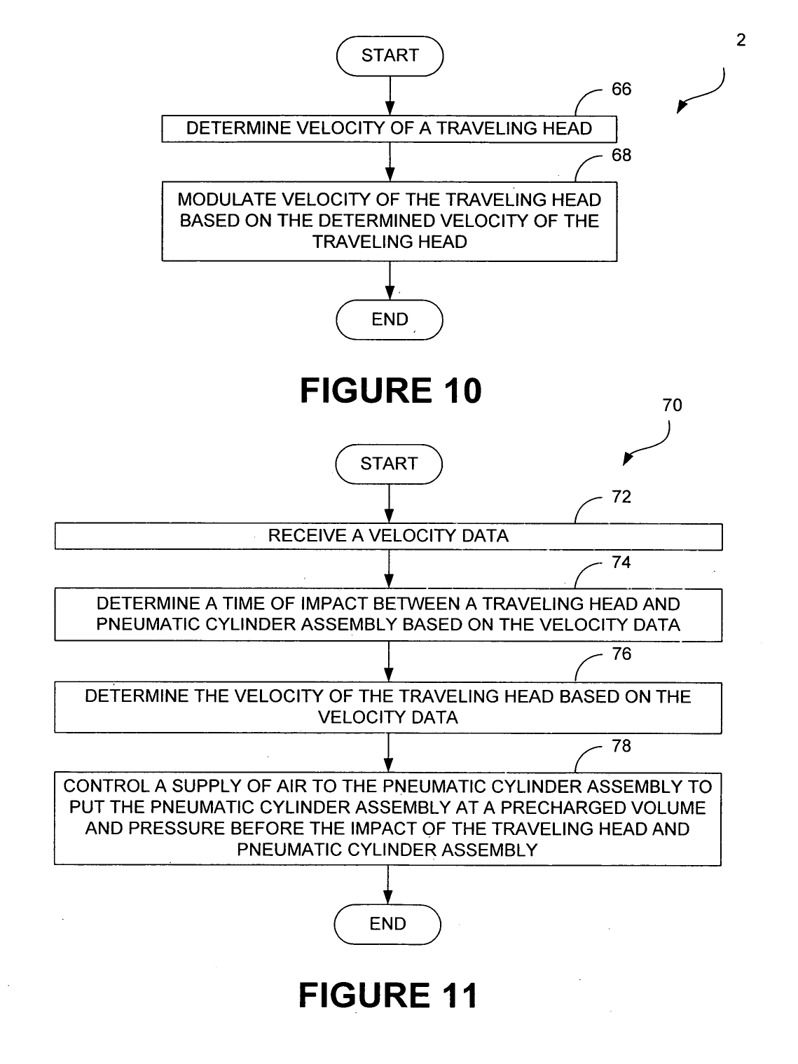

FIG. 10 illustrates a high-level example of operation of the computing device 2 shown in FIGS. 1, 2, and 3. Beginning with block 66, the computing device 2 determines a velocity of a traveling head. In block 68, the computer device 2 modulates the velocity of the traveling head based on the determined velocity.

FIG. 11 illustrates an embodiment of operation of a propulsion manager 70 stored in the computing device 2. The flow chart of FIG. 11 shows the architecture, functionality, and operation of a possible implementation of the propulsion manager 70. In this regard, each block represents a module, segment, or portion of code, which comprises one or more executable instructions for implementing the specified logical function(s). It should also be noted that in some alternative implementations, the functions noted in the blocks may occur out of the order noted in FIG. 11. For example, two blocks shown in succession in FIG. 11 may in fact be executed substantially concurrently or the blocks may sometimes be executed in the reverse order, depending upon the functionality involved, as will be further clarified hereinbelow.

Beginning with block 72, the propulsion manager receives a velocity data. In block 74, the manager 70 determines the time of impact between a traveling head and a pneumatic cylinder assembly based on the velocity data. In block 76, the manager 70 also determines the velocity of the traveling head based on the velocity data. In block 78, based on the velocity data, the propulsion manager 70 controls the supply of air to the pneumatic cylinder assembly to put the pneumatic cylinder assembly at a precharged volume and pressure before the impact of the traveling head and pneumatic cylinder assembly.

It should be emphasized that the above-described embodiments of the present invention, particularly, any “preferred” embodiments, are merely possible examples of implementations, merely set forth for a clear understanding of the principles of the invention. Many variations and modifications may be made to the above-described embodiment(s) of the invention without departing substantially from the spirit and principles of the invention. All such modifications and variations are intended to be included herein within the scope of this disclosure and the present invention and protected by the following claims.

Therefore, having thus described the invention, at least the following is claimed:

1. A scanning apparatus comprising:
a traveling head that travels in a linear motion;
at least one propulsion member that propels the traveling head at a velocity at the ends of travel; and
a computing device that determines the velocity of the traveling head from a velocity data and controls the at least one propulsion member to modulate the velocity of the traveling head.

2. The scanning apparatus as defined in claim 1, further comprising an air supply that facilitates propelling the traveling head.

3. The scanning apparatus as defined in claim 2, wherein the at least one propulsion member further comprises at least one pneumatic cylinder assembly at the end of travel of the traveling head, the at least one pneumatic cylinder assembly being capable of receiving air from the air supply and propelling the traveling head.

4. The scanning apparatus as defined in claim 3, wherein the at least one pneumatic cylinder assembly is capable of recovering most of the energy from the velocity of the traveling head as the traveling head impacts the at least one pneumatic cylinder at the end of travel and using the recovered energy to propel the traveling head in the opposite direction.

5. The scanning apparatus as defined in claim 4, wherein the pneumatic cylinder assembly comprises a piston, a precharge section, and a pressurized section, the piston is arranged in the precharge section of the pneumatic cylinder assembly, the precharge section having a precharged volume and pressure, the pressurized section having a pressure greater than atmosphere;
when the traveling head impacts the piston, the volumes expands and the pressure decreases in the precharge section;
as the traveling head deflects the piston, the pressurized section remains at the pressure greater than atmosphere; and
at the apex of deflection, the pressure differential across the piston propels the piston and in turn propels the traveling head in the opposite direction.

6. The scanning apparatus as defined in claim 4, wherein the traveling head is mounted with at least one piston that engages and enters the at least one pneumatic cylinder assembly when the traveling head impacts the pneumatic cylinder assembly; and
at the apex of the penetration, air is added to the pneumatic cylinder assembly to propel the traveling head in the opposite direction.

7. The scanning apparatus as defined in claim 4, wherein the traveling head comprises an air bearing that includes a combination of cylindrical bearing and a flat bearing arranged so as to constrain the motion to a linear motion without over constraint.

8. The scanning apparatus as defined in claim 7, wherein the traveling head includes an air tank for supplying air to the air bearing.

9. The scanning apparatus as defined in claim 8, wherein the air tank is provided with air tetherlessly.

10. The scanning apparatus as defined in claim 8, wherein traveling head is mounted with at least one piston, the at least one piston being capable of entering the at least one pneumatic cylinder, wherein the at least one piston comprises a cylinder rod that is coupled to the air tank and receives air from the pneumatic cylinder to provide air to the air tank.

11. The scanning apparatus as defined in claim 8, further comprising a needle-like tube that engages the traveling head at the end of travel and provides air to the air tank.

12. The scanning apparatus as defined in claim 8, wherein the pneumatic cylinder is mounted with a piston, the piston comprises a cylinder rod that engages the air tank as the traveling head impacts the pneumatic cylinder and facilitates providing air to the air tank.

13. The scanning apparatus as defined in claim 2, wherein the source of propulsion further comprises one of a conventional spring and a magnetically driven motor/generator at one end of travel of the traveling head that propels the traveling head.

14. The scanning apparatus as defined in claim 1, further comprising at least one photo detector providing the velocity data to the controller so as to facilitate calculating the velocity of the traveling head.

15. The scanning apparatus as defined in claim 14, wherein the traveling head comprises an interrupter that passes through the photo detector triggering the photo detector to provide the velocity data to the controller so as to facilitate calculating the velocity of the traveling head.

16. The scanning apparatus as defined in claim 15, wherein the computing device uses the velocity data to calculate a time delay before a signal is sent to the source of propulsion to propel the traveling head.

17. The scanning apparatus as defined in claim 1, further comprising a table.

18. The scanning apparatus as defined in claim 17, further comprising a track that allows the traveling head to travel in the linear motion; the track being mounted on the table.

19. The scanning apparatus as defined in claim 18, further comprising a suspended structure that is mounted on the table; the suspended structure being capable of suspending the propulsion member, wherein the suspended structure in conjunction with the propulsion member being at a weight that dampens bouncing forces so that the scanning apparatus as a whole settles into a periodic motion with both the traveling head and the suspended structure moving back and forth.

20. The scanning apparatus as defined in claim 19, wherein the suspended structure is attached to suspended members that suspend a heavy structure, the heavy structure being mounted with the pneumatic cylinder assemblies that are arranged at the ends of travel of the traveling head, the heavy structure in conjunction with the propulsion member being at a weight that dampens bouncing forces so that the scanning apparatus as a whole settles into a periodic motion with both the traveling head and the heavy structure moving back and forth.

21. The scanning apparatus as defined in claim 18, further comprising a beam structure that is mounted separate from the table; the beam structure being mounted with the pneumatic cylinders at the ends of travel of the traveling head.

22. The scanning apparatus as defined in claim 1, wherein the traveling head includes a sensor that is directed to a material surface, where the sensor senses or modifies a surface of a material

23. The scanning apparatus as defined in claim 22, wherein the sensor is arranged at a distance from the surface of the material, the distance being adjustable so as to compensate for the inaccuracies of the construction of the air bearing or the flatness of the surface of the material.

24. The scanning apparatus as defined in claim 22, wherein the adjustable distance between the sensor and the surface of the material is based on a learned profile, which is data obtained from previous and nearby scans of the surface.

25. The scanning apparatus as defined in claim 22, further comprising a power source that is provided to the traveling head tetherlessly.

26. The scanning apparatus as defined in claim 25, wherein the power source is provided at least in part by a battery or capacitor that stores electric energy.

27. The scanning apparatus as defined in claim 25, wherein the power required is at least in part provided by a solar cell attached to the traveling head and a light is arranged to shine on the solar cells.

28. The scanning apparatus as defined in claim 25, where the power required is at least in part provided by transformer action with a coil moving with the head and one or more coils or magnets stationary and there being no contact between the coils.

29. The scanning apparatus as defined in claim 26, where the battery or capacitor is recharged by contacts when the traveling head impacts the pneumatic cylinders.

30. The scanning apparatus as defined in claim 22, where the traveling head communicates with the computing device via wireless.

31. The scanning apparatus as defined in claim 30, where the wireless communications are by modulated light, either infrared or radio.

32. A scanning apparatus comprising:
a traveling head that travels in a linear motion;
air supply that facilitates propelling the traveling head;
at least one pneumatic cylinder assembly at the end of travel of the traveling head, the at least one pneumatic cylinder assembly being capable of receiving air from the air supply and propelling the traveling head; and
a computing device that determines a velocity of the traveling head from a velocity data and controls the at least one pneumatic cylinder assembly to modulate the velocity of the traveling head.

33. The scanning apparatus as defined in claim 32, wherein the at least one pneumatic cylinder assembly is capable of recovering most of the energy from the velocity of the traveling head as the traveling head impacts the at least one pneumatic cylinder at the end of travel and using the recovered energy to propel the traveling head in the opposite direction.

34. The scanning apparatus as defined in claim 33,
wherein the pneumatic cylinder assembly comprises a piston, a precharge section, and an pressurized section, the piston being arranged in the precharge section of the pneumatic cylinder assembly, the precharge section having a precharged volume and pressure, the pressurized section having a pressure greater than atmosphere;
when the traveling head impacts the piston, the volume expands and the pressure decreases in the precharge section;
as the traveling head deflects the piston, the pressurized section remains at the pressure greater than atmosphere; and
at the apex of deflection, the pressure differential across the piston propels the piston and in turn propels the traveling head in the opposite direction.

35. The scanning apparatus as defined in claim 33, wherein the traveling head is mounted with at least one piston that engages and enters the pneumatic cylinder assembly when the traveling head impacts the pneumatic cylinder; and
at the apex of the penetration, air is added to propel the traveling head in the opposite direction.

36. The scanning apparatus as defined in claim 32, wherein the traveling head comprises an air bearing that includes a combination of cylindrical bearing and a flat bearing arranged so as to constrain the motion to a linear motion.

37. The scanning apparatus as defined in claim 36, wherein the traveling head includes an air tank for supplying air to the air bearing.

38. The scanning apparatus as defined in claim 37, wherein the air tank is provided with air tetherlessly.

39. The scanning apparatus as defined in claim 37, wherein traveling head is mounted with at least one piston, the at least one piston being capable of entering the at least one pneumatic cylinder assembly, wherein the at least one piston comprises a cylinder rod that is coupled to the air tank and receives air from the pneumatic cylinder assembly to provide air to the air tank.

40. The scanning apparatus as defined in claim 37, further comprising a needle-like tube that engages the traveling head at the end of travel and provides air to the air tank.

41. The scanning apparatus as defined in claim 37, wherein the pneumatic cylinder assembly is mounted with a piston, the piston comprises a cylinder rod that engages the air tank as the traveling head impacts the pneumatic cylinder assembly and facilitates providing air to the air tank.

42. The scanning apparatus as defined in claim 32, wherein the source of propulsion further comprises one of a conventional spring and a magnetically driven motor/generator at one end of travel of the traveling head that propels the traveling head.

43. The scanning apparatus as defined in claim 32, further comprising at least one photo detector providing the velocity data to the controller so as to facilitate calculating the velocity of the traveling head.

44. The scanning apparatus as defined in claim 43, wherein the traveling head comprises an interrupter that passes through the photo detector triggering the photo detector to provide the velocity data to the controller so as to facilitate calculating the velocity of the traveling head.

45. The scanning apparatus as defined in claim 44, wherein the computing device uses the velocity data to calculate a time delay before a signal is sent to the source of propulsion to propel the traveling head.

46. The scanning apparatus as defined in claim 32, further comprising a table.

47. The scanning apparatus as defined in claim 46, further comprising a track that allows the traveling head to travel in the linear motion; the track being mounted on the table.

48. The scanning apparatus as defined in claim 47, further comprising a suspended structure that is mounted on the table; the suspended structure being mounted with the pneumatic cylinder assembly, wherein the suspended structure in conjunction with the propulsion member being at a weight that dampens bouncing forces so that the scanning apparatus as a whole settles into a periodic motion with both the traveling head and the suspended structure moving back and forth.

49. The scanning apparatus as defined in claim 48, wherein the suspended structure is attached to suspended members that suspend a heavy structure, the heavy structure is mounted with the pneumatic cylinder assemblies that are arranged at the ends of travel of the traveling head, the heavy structure in conjunction with the propulsion member being at a weight that dampens bouncing forces so that the scanning apparatus as a whole settles into a periodic motion with both the traveling head and the heavy structure moving back and forth.

50. The scanning apparatus as defined in claim 48, further comprising a beam structure that is mounted separate from the table; the beam structure being mounted with the pneumatic cylinders at the ends of travel of the traveling head.

51. The scanning apparatus as defined in claim 32, wherein the traveling head includes a sensor that is directed to a material surface, where the sensor senses or modifies a surface of a material

52. The scanning apparatus as defined in claim 51, wherein the sensor is arranged at a distance from the surface of the material, the distance being adjustable so as to compensate for the inaccuracies of the construction of the air bearing or the flatness of the surface of the material.

53. The scanning apparatus as defined in claim 51, wherein the adjustable distance between the sensor and the surface of the material is based on a learned profile, which is data obtained from previous and nearby scans of the surface.

54. The scanning apparatus as defined in claim 51, further comprising a power source that is provided to the traveling head tetherlessly.

55. The scanning apparatus as defined in claim 54, wherein the power source is provided at least in part by a battery or capacitor that stores electric energy.

56. The scanning apparatus as defined in claim 54, wherein the power required is at least in part provided by a solar cell attached to the traveling head and a light is arranged to shine on the solar cells.

57. The scanning apparatus as defined in claim 54, where the power required is at least in part provided by transformer action with a coil moving with the head and one or more coils or magnets stationary and there being no contact between the coils.

58. The scanning apparatus as defined in claim 55, where the battery or capacitor is recharged by contacts when the traveling head impacts the pneumatic cylinders.

59. The scanning apparatus as defined in claim 54, where the traveling head communicates with the computing device via wirelessly, the traveling head transmits data from the sensor.

60. The scanning apparatus as defined in claim 59, where the wireless communications are by modulated light, either the infrared or radio.

61. A scanning apparatus comprising:
a traveling head that travels in a linear motion;
air supply that facilitates propelling the traveling head;
at least one pneumatic cylinder assembly at the end of travel of the traveling head, the at least one pneumatic cylinder assembly being capable of receiving air from the air supply and propelling the traveling head; and
a computing device that determines a velocity of the traveling head from a velocity data and controls the at least one pneumatic cylinder assembly to modulate the velocity of the traveling head,
wherein the pneumatic cylinder assembly comprises a piston, a precharge section, and an pressurized section, the piston is arranged in the precharge section of the pneumatic cylinder assembly, the precharge section having a precharged volume and pressure, the pressurized section having a pressure greater than atmosphere, when the traveling head impacts the piston the volume expands and the pressure decreases in the precharge section, as the traveling head deflects the piston the pressurized section remains at the pressure greater than atmosphere, and at the apex of deflection, the pressure differential across the piston propels the piston and in turn propels the traveling head in the opposite direction.

62. A scanning apparatus comprising:
a traveling head that travels in a linear motion;
at least one propulsion member that propels the traveling head at a velocity at the ends of travel;
a computing device that determines a velocity of the traveling head from a velocity data and controls the at least one propulsion member to modulate the velocity of the traveling head;
a table;
a track that allows the traveling head to travel in the linear motion; the track being mounted on the table; and
a suspended structure that is mounted on the table; the suspended structure is attached to suspended members that suspend a heavy structure, the heavy structure is mounted with the pneumatic cylinder assemblies that are arranged at the ends of travel of the traveling head, the heavy structure in conjunction with the propulsion member being at a weight that dampens bouncing forces so that the scanning apparatus as a whole settles into a periodic motion with both the traveling head and the heavy structure moving back and forth.

63. A scanning apparatus comprising:
a traveling head that travels in a linear motion;
at least one propulsion member that propels the traveling head at a velocity at the ends of travel;
a computing device that determines a velocity of the traveling head from a velocity data and controls the at least one propulsion member to modulate the velocity of the traveling head;
a table;
a track that allows the traveling head to travel in the linear motion; the track being mounted on the table; and
a beam structure that is mounted separate from the table, the beam structure being mounted with the pneumatic cylinders at the ends of travel of the traveling head.

64. A scanning apparatus comprising:
a traveling head that travels in a linear motion, the traveling head including a sensor;
at least one propulsion member that propels the traveling head at a velocity at the ends of travel; and
a computing device that determines a velocity of the traveling head from a velocity data and controls the at least one propulsion member to modulate the velocity of the traveling head;
wherein the sensor is arranged at a distance from the surface of the material, the distance being adjustable so as to compensate for the inaccuracies of the construction of the air bearing or the flatness of the surface of the material, wherein the adjustable distance between the sensor and the surface of the material is based on a learned profile, which is data obtained from previous and nearby scans of the surface.

65. A propulsion manager stored in a computer-readable medium, the manager performing the steps of:
receiving a velocity data;
determining a time of impact between a traveling head and a pneumatic cylinder assembly;
determining a velocity of the traveling head based on the velocity data; and
controlling a supply of air to the pneumatic cylinder at a precharged volume and pressure before the impact of the traveling head and pneumatic cylinder assembly.
